(19) United States
(12) Patent Application Publication
(10) Pub. No.: US 2018/0322839 A1
(43) Pub. Date: Nov. 8, 2018

(54) DISPLAY PANEL AND DISPLAY APPARATUS USING SAME

(71) Applicants: HKC CORPORATION LIMITED, Shenzhen City, Guangdong (CN); CHONGQING HKC OPTOELECTRONICS TECHNOLOGY CO., LTD., Chongqing (CN)

(72) Inventor: Yu-Jen CHEN, Chongqing (CN)

(21) Appl. No.: 15/555,871

(22) PCT Filed: May 17, 2017
(86) PCT No.: PCT/CN2017/084672

§ 371 Date: Sep. 5, 2017

(30) Foreign Application Priority Data
May 5, 2017 (CN) 201710313703.3

(51) Int. Cl. G09G 3/36; G02F 1/1345; G02F 1/1368; G02F 1/1362

(52) U.S. Cl. CPC G09G 3/3655; G02F 1/136286; G02F 1/1368; G02F 1/1345

(57) ABSTRACT

This application relates to a display panel and a display apparatus using same. The display panel includes: a control board (C-Board); a common voltage regulating unit, connected to the C-Board, where the common voltage regulating unit includes a common voltage generation circuit, a voltage comparator, and a voltage regulator; and an active element array substrate, connected to the common voltage regulating unit and connected to the C-Board by using a signal drive circuit. According to this application, a common voltage may be automatically detected, compared, and regulated by disposing the common voltage regulating unit.

### BACKGROUND

### Technical Field

This application relates to a display panel and a display apparatus using same, and in particular, to a display panel and an apparatus thereof having a common voltage regulating architecture and configured to automatically detect, compare, and regulate a common voltage.

### Related Art

Liquid crystal display panels have advantages such as high picture quality, a small volume, a light design, low-voltage driving, low power consumption, and wide application range. Therefore, the liquid crystal display panels are widely applied to consumer electronic products such as small and mid-size portable televisions, mobile phones, video cameras, notebook computers, and laptop displays, and gradually replace cathode ray tubes (CRTs) and become main parts of displays. A liquid crystal display panel mainly includes an active element array substrate, a color filter substrate, and a liquid crystal layer between the two substrates.

A main driving principle of a liquid crystal display panel: a R/G/B compression signal, a control signal, and power are connected to a connector on a control board (C-Board) by a system main board by using a wire, data is transmitted to signal drive circuits (a scanning signal drive circuit and data signal drive circuit) through a flexible flat circuit (FFC) after IC processing is performed on the data by a timing controller (TCON) on the C-Board, and is connected to a display area by using a source-chip on film (S-COF) and a gate-chip on film (G-COF), so that the liquid crystal display panel obtains required power and signal.

Display of the liquid crystal display panel is implemented by means of voltage driving. During the display, a reference voltage needs to be transmitted to a common voltage generation circuit to generate a common voltage, to supply power. Because the process is unstable, an optimal common voltage of each liquid crystal panel is different, and needs to be regulated according to an actual feature of each panel. In the related art, a C-Board outputs a reference voltage and generates a common voltage by using a digital voltage regulator (DVR) or a voltage regulator (VR), and outputs the common voltage to a liquid crystal panel. Because panels and C-Boards are separately shipped when products are shipped to a customer, the panels cannot correspondingly match the C-Boards. Consequently, common voltage of the panels after they are assembled are not optimal.

### SUMMARY

To resolve the foregoing technical problem, an objective of this application is to provide a display panel having a common voltage regulating architecture, comprising: a C-Board; a common voltage regulating unit, electrically connected to the C-Board, where the common voltage regulating unit comprises a common voltage generation circuit, a voltage comparator, and a voltage regulator electrically connected to each other; and an active element array substrate, electrically connected to the common voltage regulating unit, and connected to the C-Board by using a signal drive circuit, where the C-Board outputs a reference voltage to the common voltage generation circuit, the common voltage generation circuit transmits the reference voltage to the voltage comparator for record or comparison, the common voltage generation circuit is fed back and regulated, by using the voltage regulator according to a comparison result of the voltage comparator, and a common voltage is input to the active element array substrate, so that the common voltage of the active element array substrate is maintained stable.

In an embodiment of this application, the signal drive circuit comprises a scanning signal drive circuit and a data signal drive circuit.

In an embodiment of this application, the scanning signal drive circuit and the data signal drive circuit each are connected to the C-Board by using a flexible flat cable (FFC).

In an embodiment of this application, the active element array substrate comprises a substrate, the substrate comprises a display area and a plurality of scanning wires, disposed on the substrate and connected to the scanning signal drive circuit and a plurality of data wires, disposed on the substrate and connected to the data signal drive circuit and a plurality of active elements, disposed on the substrate, and arranged in an array in the display area, and each of the active elements is electrically connected to the corresponding scanning wire and the corresponding data wire, where the scanning signal drive circuit is electrically connected to the active elements in the display area by using a gate-chip on film (G-COF), and the data signal drive circuit is electrically connected to the active element in the display area by using a source-chip on film (S-COF).

In an embodiment of this application, after the common voltage generation circuit transmits the reference voltage to the voltage comparator, the voltage comparator obtains a logic voltage by comparing the reference voltage with a voltage of the active element array substrate.

In an embodiment of this application, the logic voltage is a high voltage when the reference voltage is greater than the voltage of the active element array substrate, and the logic voltage is a low voltage when the reference voltage is less than the voltage of the active element array substrate.

In an embodiment of this application, when the logic voltage is a high voltage, the voltage comparator outputs a signal to enable the voltage regulator to reduce the common voltage of the common voltage generation circuit, and inputs the reduced common voltage to the active element array substrate.

In an embodiment of this application, when the logic voltage is a low voltage, the voltage comparator outputs a signal to enable the voltage regulator to increase the common voltage of the common voltage generation circuit, and inputs the increased common voltage to the active element array substrate.

In an embodiment of this application, when the reference voltage is equal to a voltage of the active element array substrate, the voltage comparator does not output a signal to enable the voltage regulator to regulate the common voltage generation circuit.

To resolve the technical problem, this application may be further implemented by adopting the following technical measure, that is, providing a display apparatus having a common voltage regulating architecture, including a backlight module, and further including the display panel.

This application can avoid a common voltage drift resulting from a panel matching different C-Boards, thereby maintaining stability of a panel common voltage, and suppressing flicker.

### BRIEF DESCRIPTION OF THE DRAWINGS

FIG. 1A is a schematic diagram of an exemplary common voltage regulating manner;

FIG. 1B is a schematic diagram of another exemplary common voltage regulating manner;

FIG. 2 is a schematic diagram of a common voltage regulating architecture according to this application;

FIG. 3A is a schematic diagram of a regulating manner according to an embodiment of this application;

FIG. 3B is a schematic diagram of a regulating manner according to another embodiment of this application; and

FIG. 3C is a schematic diagram of no regulation according to an embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using the same reference number. In addition, for understanding and ease of description, the size and the thickness of each element shown in the accompanying drawings are arbitrarily shown, but this application is not limited thereto.

In the accompanying drawings, for clarity, representation manners of circuit boards, circuit components, lines, and the like are simplified. In the accompanying drawings, for understanding and ease of description, representations of some circuit components are enlarged. It should be understood that when a component such as a circuit board, a circuit component, or a panel is described to be “on” another component, the component may be directly on the another component, or there may be an intermediate component.

In addition, in this specification, unless otherwise explicitly described to have an opposite meaning, the word “include” is understood as including the element, but not excluding any other element. In addition, in this specification, “on” means on or under a target element rather than on a top based on a gravity direction.

To further describe the technical means adopted in this application to achieve the intended inventive objective and effects thereof, specific implementations, structures, features, and effects of a display panel and a display apparatus using same provided according to this application are described below in detail with reference to the drawings and preferred embodiments.

To prevent a liquid crystal material of a liquid crystal display apparatus from aging, AC transformation is performed to an electric potential applied between “a voltage of an active element array substrate” and “a reference voltage”, to avoid continuously applying a direct current voltage for a long period of time. However, a polarity of the electric potential between the voltage of the active element array substrate and the reference voltage is reversed by using one or more frame units, to averagely prevent applying a direct current voltage for a long period of time. It is observed from each frame unit that, a given electric potential is nearly applied in a range of the voltage of the active element array substrate.

However, the polarity of the electric potential between the voltage of the active element array substrate and the reference voltage is reversed by using one or more frame units only when the liquid crystal display apparatus includes a power supply. That is, after the power supply is cut off, the given electric potential nearly applied in the range of the voltage of the active element array substrate is still maintained. When an active element is maintained in a closed state, the voltage of the active element array substrate is still maintained in a closed state for a long period of time when the power supply of the liquid crystal display apparatus is cut off, and the given electric potential in the range of the voltage of the active element array substrate is continuously maintained for a long period of time.

In addition, because the reference voltage is supplied with an electric potential rather than passing through an ordinary active element having pixel units, conversely, after the power supply of the liquid crystal display apparatus is cut off, the electric potential rapidly reaches a GND potential (used as a ground potential for reference).

A result confirms that, for the liquid crystal display apparatus having the active element, in a case in which the power supply of the liquid crystal display apparatus is cut off, a DC potential difference is supplied between the voltage of the active element array substrate and the reference voltage for a long period of time, and pixels have a direct current. Therefore, even though power is supplied to the liquid crystal display apparatus again, in this case, an electric potential between the voltage of the active element array substrate and the reference voltage drives an AC signal formation on a residual DC potential, generating unbalance on a liquid crystal driving voltage between polarities, causing flicker.

Therefore, this application provides a display panel and a display apparatus using same, to avoid a common voltage drift resulting from a panel matching different C-Boards, thereby maintaining stability of a panel common voltage, and suppressing flicker.

In different embodiments, for example, the display panel may be a liquid crystal display panel or another display panel.

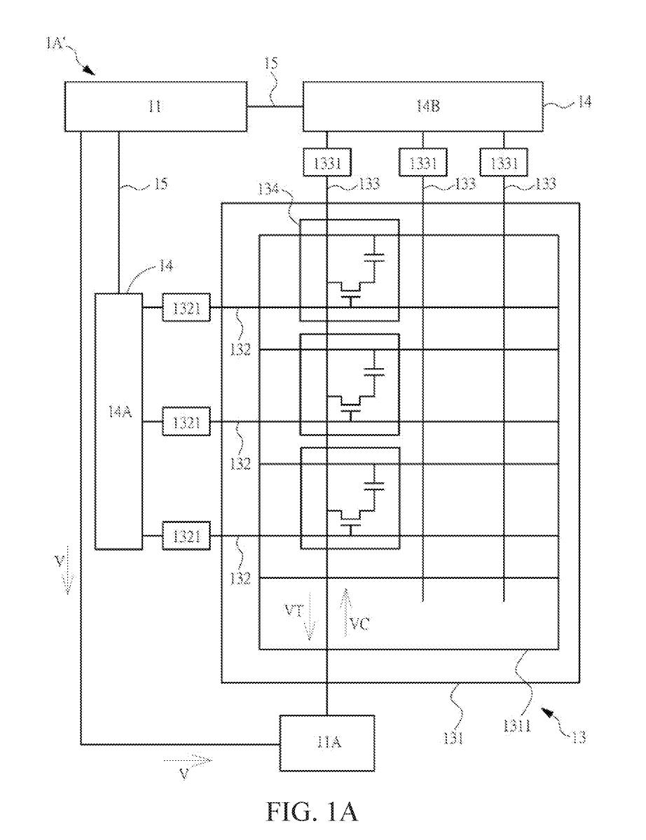

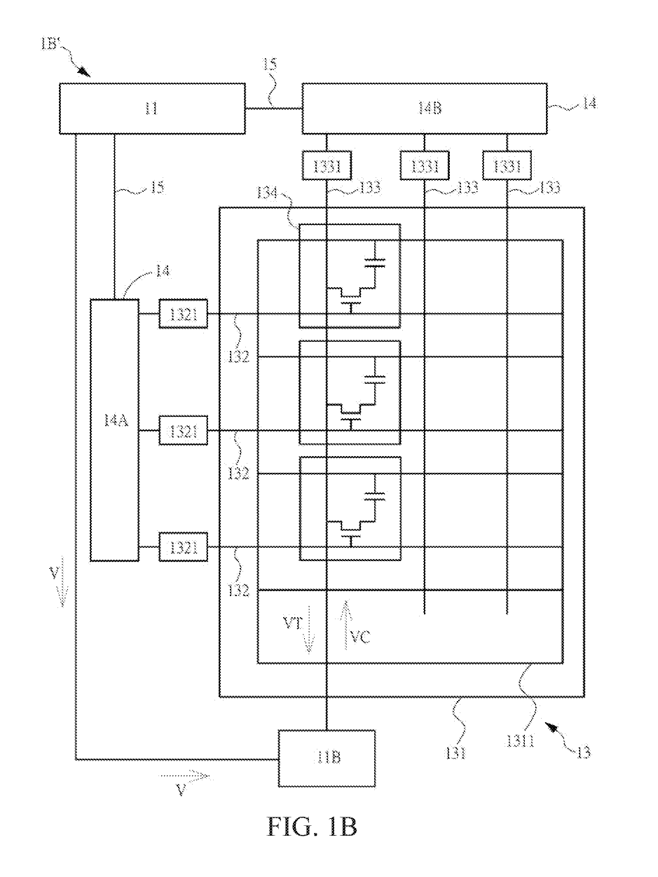

Referring to FIG. 1A and FIG. 1B, FIG. 1A and FIG. 1B are schematic diagrams of two exemplary common voltage regulating manners. As shown in FIG. 1A and FIG. 1B, an exemplary common voltage regulating manner 1A′ and an exemplary common voltage regulating manner 1B′ include a C-Board 11, a DVR 11A or a VR 11B, and an active element array substrate 13, electrically connected to the DVR 11A or the VR 11B and connected to the C-Board 11 by using a signal drive circuit 14. The signal drive circuit 14 includes a scanning signal drive circuit 14A and a data signal drive circuit 14B. The scanning signal drive circuit 14A and the data signal drive circuit 14B each are connected to the C-Board 11 by using an FFC 15. The active element array substrate 13 includes a substrate 131. The substrate 131 includes a display area 1311 and a plurality of scanning wires 132, disposed on the substrate 131 and connected to the scanning signal drive circuit 14A and a plurality of data wires 133, disposed on the substrate 131 and connected to the data signal drive circuit 14B and a plurality of active elements 134, disposed on the substrate 131, and arranged in an array in the display area 1311. Each of the active elements 134 is electrically connected to the corresponding scanning wire 132 and the corresponding data wire 133. The scanning signal drive circuit 14A is electrically connected to the active elements 134 in the display area 1311 by using a G-COF 1321, and the data signal drive circuit 14B is electrically connected to the active elements 134 in the display area 1311 by using an S-COF 1331.

As shown in FIGS. 1A and 1B, the C-Board 11 outputs a reference voltage V, generates a common voltage VC by using the DVR 11A (Digital Voltage Regulator, DVR) or the VR 11B, and outputs the common voltage VC to the active element array substrate 13 of the display panel. However, a voltage VT of the active element array substrate may be inconsistent with the common voltage VC generated by the DVR 11A or the VR 11B. Consequently, a problem of a common voltage drift easily occurs.

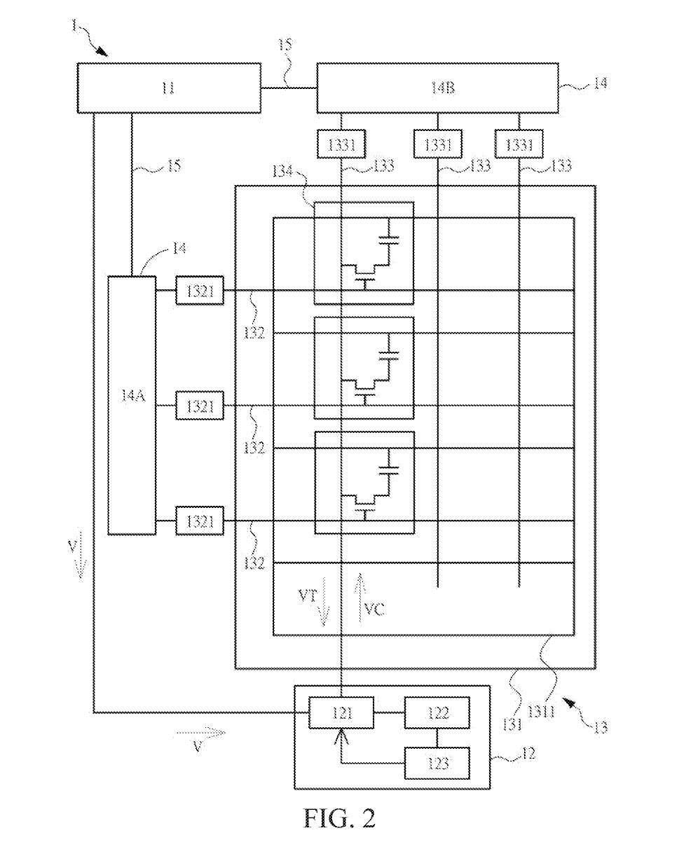

FIG. 2 is a schematic diagram of a common voltage regulating architecture according to this application. Referring to FIG. 2, in an embodiment, a common voltage regulating architecture 1 includes: a C-Board 11; a common voltage regulating unit 12, electrically connected to the C-Board 11, where the common voltage regulating unit 12 includes a common voltage generation circuit 121, a voltage comparator 122, and a voltage regulator 123 electrically connected to each other; and an active element array substrate 13, electrically connected to the common voltage regulating unit 12 and connected to the C-Board 11 by using a signal drive circuit 14. The C-Board 11 outputs a reference voltage V to the common voltage generation circuit 121. The common voltage generation circuit 121 transmits the reference voltage V to the voltage comparator 122 for record or comparison. The common voltage generation circuit 121 is fed back and regulated by using the voltage regulator 123 according to a comparison result of the voltage comparator 122, and a common voltage VC is input to the active element array substrate 13, so that the common voltage VC of the active element array substrate 13 is maintained stable.

In an embodiment, the signal drive circuit 14 of this application includes a scanning signal drive circuit 14A and a data signal drive circuit 14B. The scanning signal drive circuit 14A and the data signal drive circuit 14B each are connected to the C-Board 11 by using an FFC 15.

In an embodiment, the active element array substrate 13 of this application includes a substrate 131. The substrate 131 includes a display area 1311 and a plurality of scanning wires 132, disposed on the substrate 131 and connected to the scanning signal drive circuit 14A and a plurality of data wires 133, disposed on the substrate 131 and connected to the data signal drive circuit 14B and a plurality of active elements 134, disposed on the substrate 131, and arranged in an array in the display area 1311. Each of the active elements 134 is electrically connected to the corresponding scanning wire 132 and the corresponding data wire 133. The scanning signal drive circuit 14A is electrically connected to the active elements 134 in the display area 1311 by using a G-COF 1321, and the data signal drive circuit 14B is electrically connected to the active elements 134 in the display area 1311 by using an S-COF 1331.

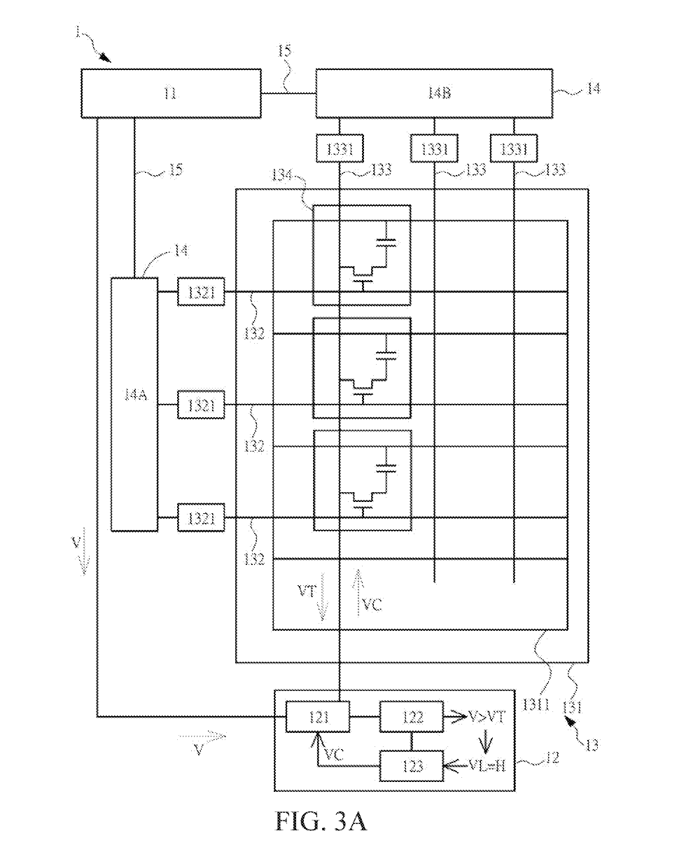

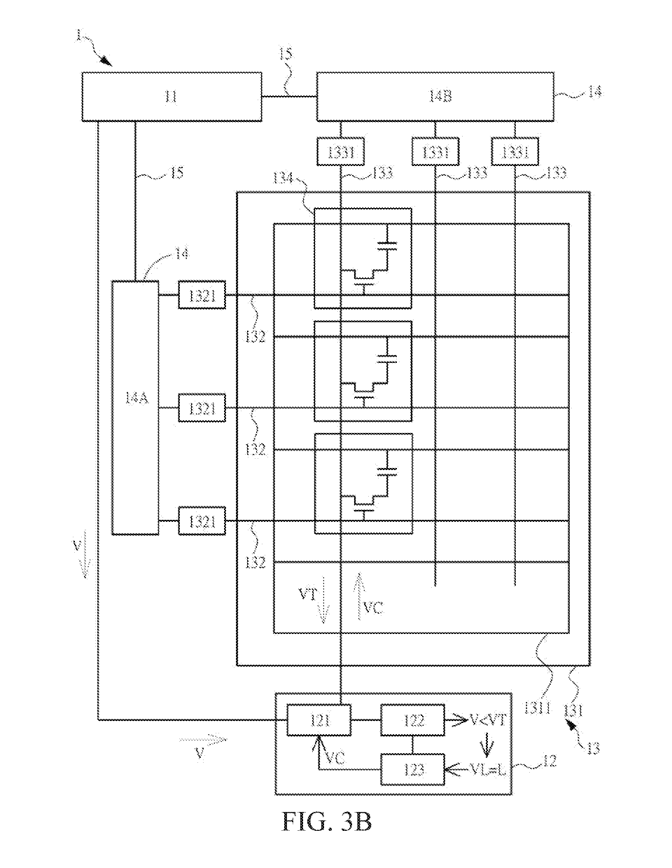

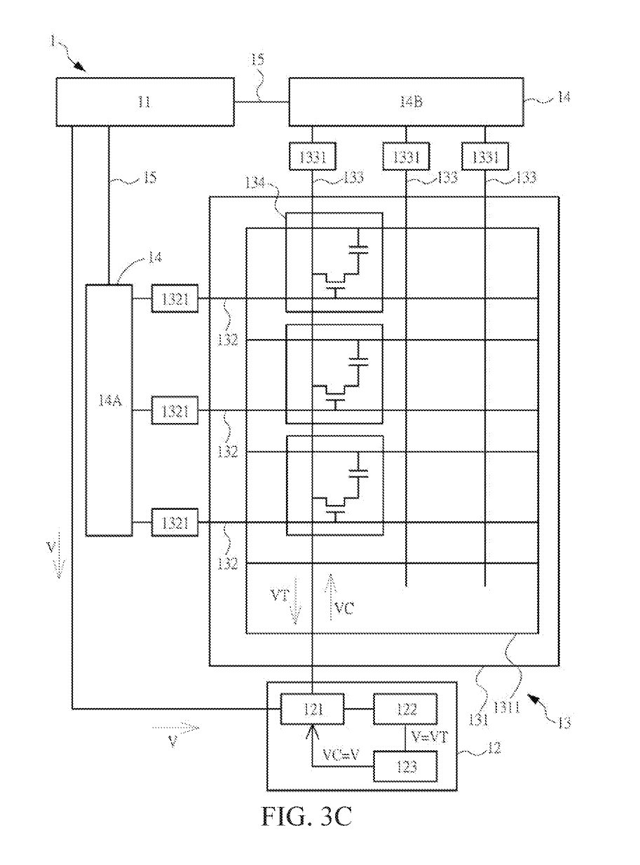

That is, the maximum difference between this application and the exemplary common voltage regulating manners is the common voltage regulating unit 12 of this application. Operation of the common voltage regulating unit 12 is described below. Refer to FIG. 3A to FIG. 3C.

In an embodiment of this application, after the common voltage generation circuit 121 transmits the reference voltage V to the voltage comparator 122, the voltage comparator 122 obtains a logic voltage VL by comparing the reference voltage V with a voltage VT of the active element array substrate.

In an embodiment of this application, the logic voltage VL is a high voltage H when the reference voltage V is greater than the voltage VT of the active element array substrate, and the logic voltage VL is a low voltage L when the reference voltage V is less than the voltage VT of the active element array substrate.

Referring to FIG. 3A, in an embodiment of this application, when the reference voltage V is greater than the voltage VT of the active element array substrate, that is, when the logic voltage VL is the high voltage H, the voltage comparator 122 outputs a signal to enable the voltage regulator 123 to reduce a common voltage VC of the common voltage generation circuit 121, and input the reduced common voltage VC to the active element array substrate 13.

Referring to FIG. 3B, in an embodiment of this application, when the reference voltage V is less than the voltage VT of the active element array substrate, that is, when the logic voltage VL is the low voltage L, the voltage comparator 122 outputs a signal to enable the voltage regulator 123 to increase the common voltage VC of the common voltage generation circuit 121, and inputs the increased common voltage VC to the active element array substrate 13.

Finally, referring to FIG. 3C, in an embodiment of this application, when the reference voltage V is equal to the voltage VT of the active element array substrate, the voltage comparator 122 directly uses the reference voltage V transmitted by the C-Board 11 as the common voltage VC and inputs the common voltage VC to the active element array substrate 13 instead of outputting a signal to the voltage regulator 123 to regulate the common voltage generation circuit 121, so that the common voltage VC of the active element array substrate 13 is maintained stable.

Referring to FIG. 2 to FIG. 3C, in an embodiment, a display apparatus includes a backlight module, and further includes a display panel 1 having the common voltage regulating architecture.

This application can avoid a common voltage drift resulting from a panel matching different C-Boards, thereby maintaining stability of a panel common voltage, and suppressing flicker.

Terms such as “in some embodiments” and “in various embodiments” are repeatedly used. The terms usually refer to different embodiments, but may refer to a same embodiment. Words such as “include”, “have”, and “include” are synonyms, unless other meanings are indicated in the context.

The foregoing descriptions are merely preferred embodiments of this application, but are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A display panel, comprising:
a control board (C-Board);
a common voltage regulating unit, electrically connected to the C-Board, wherein the common voltage regulating unit comprises a common voltage generation circuit, a voltage comparator, and a voltage regulator electrically connected to each other; and
an active element array substrate, electrically connected to the common voltage regulating unit, and connected to the C-Board by using a signal drive circuit, wherein
the C-Board outputs a reference voltage to the common voltage generation circuit, the common voltage generation circuit transmits the reference voltage to the voltage comparator for record or comparison, the common voltage generation circuit is fed back and regulated by using the voltage regulator according to a comparison result of the voltage comparator, and a common voltage is inputted to the active element array substrate, so that the common voltage of the active element array substrate is maintained stable.

2. The display panel according to claim 1, wherein the signal drive circuit comprises a scanning signal drive circuit and a data signal drive circuit.

3. The display panel according to claim 2, wherein the scanning signal drive circuit and the data signal drive circuit each are connected to the C-Board by using a flexible flat cable (FFC).

4. The display panel according to claim 2, wherein the active element array substrate comprises a substrate, the substrate comprises a display area and a plurality of scanning wires, disposed on the substrate and connected to the scanning signal drive circuit and a plurality of data wires, disposed on the substrate and connected to the data signal drive circuit and a plurality of active elements, disposed on the substrate, and arranged in an array in the display area, and each of the active elements is electrically connected to the corresponding scanning wire and the corresponding data wire.

5. The display panel according to claim 4, wherein the scanning signal drive circuit is electrically connected to the active elements in the display area by using a gate-chip on film (G-COF), and the data signal drive circuit is electrically connected to the active elements in the display area by using a source-chip on film (S-COF).

6. The display panel according to claim 1, wherein after the common voltage generation circuit transmits the reference voltage to the voltage comparator, the voltage comparator obtains a logic voltage by comparing the reference voltage with a voltage of the active element array substrate, the logic voltage is a high voltage when the reference voltage is greater than the voltage of the active element array substrate, and the logic voltage is a low voltage when the reference voltage is less than the voltage of the active element array substrate.

7. The display panel according to claim 6, wherein when the logic voltage is a high voltage, the voltage comparator outputs a signal to enable the voltage regulator to reduce the common voltage of the common voltage generation circuit, and inputs the reduced common voltage to the active element array substrate.

8. The display panel according to claim 6, wherein when the logic voltage is a low voltage, the voltage comparator outputs a signal to enable the voltage regulator to increase the common voltage of the common voltage generation circuit, and inputs the increased common voltage to the active element array substrate.

9. The display panel according to claim 1, wherein when the reference voltage is equal to a voltage of the active element array substrate, the voltage comparator does not output a signal to enable the voltage regulator to regulate the common voltage generation circuit.

10. A display apparatus, comprising:
a backlight module; and
a display panel, comprising:
a control board (C-Board);
a common voltage regulating unit, electrically connected to the C-Board, wherein the common voltage regulating unit comprises a common voltage generation circuit, a voltage comparator, and a voltage regulator electrically connected to each other; and
an active element array substrate, electrically connected to the common voltage regulating unit, and connected to the C-Board by using a signal drive circuit, wherein
the C-Board outputs a reference voltage to the common voltage generation circuit, the common voltage generation circuit transmits the reference voltage to the voltage comparator for record or comparison, the common voltage generation circuit is fed back and regulated by using the voltage regulator according to a comparison result of the voltage comparator, and a common voltage is inputted to the active element array substrate, so that the common voltage of the active element array substrate is maintained stable.

11. The display apparatus according to claim 10, wherein the signal drive circuit comprises a scanning signal drive circuit and a data signal drive circuit.

12. The display apparatus according to claim 11, wherein the scanning signal drive circuit and the data signal drive circuit each are connected to the C-Board by using a flexible flat cable (FFC).

13. The display apparatus according to claim 11, wherein the active element array substrate comprises a substrate, the substrate comprises a display area and a plurality of scanning wires, disposed on the substrate and connected to the scanning signal drive circuit and a plurality of data wires, disposed on the substrate and connected to the data signal drive circuit and a plurality of active elements, disposed on the substrate, and arranged in an array in the display area, and each of the active elements is electrically connected to the corresponding scanning wire and the corresponding data wire.

14. The display apparatus according to claim 13, wherein the scanning signal drive circuit is electrically connected to the active elements in the display area by using a gate-chip on film (G-COF), and the data signal drive circuit is electrically connected to the active elements in the display area by using a source-chip on film (S-COF).

15. The display apparatus according to claim 10, wherein after the common voltage generation circuit transmits the reference voltage to the voltage comparator, the voltage comparator obtains a logic voltage by comparing the reference voltage with a voltage of the active element array substrate, the logic voltage is a high voltage when the reference voltage is greater than the voltage of the active element array substrate, and the logic voltage is a low voltage when the reference voltage is less than the voltage of the active element array substrate.

16. The display apparatus according to claim 15, wherein when the logic voltage is a high voltage, the voltage comparator outputs a signal to enable the voltage regulator to reduce the common voltage of the common voltage generation circuit, and inputs the reduced common voltage to the active element array substrate.

17. The display apparatus according to claim 15, wherein when the logic voltage is a low voltage, the voltage comparator outputs a signal to enable the voltage regulator to increase the common voltage of the common voltage generation circuit, and inputs the increased common voltage to the active element array substrate.

18. The display apparatus according to claim 10, wherein when the reference voltage is equal to a voltage of the active element array substrate, the voltage comparator does not output a signal to enable the voltage regulator to regulate the common voltage generation circuit.
